(19) United States
(12) Patent Application Publication
(10) Pub. No.: US 2019/0039416 A1
(43) Pub. Date: Feb. 7, 2019

(54) PNEUMATIC TIRE

(71) Applicant: TOYO TIRE & RUBBER CO., LTD., Itami-shi (JP)

(72) Inventor: Tetsuji Miyazaki, Itami-shi, Hyogo (JP)

(73) Assignee: TOYO TIRE & RUBBER CO., LTD., Itami-shi (JP)

(21) Appl. No.: 16/037,565

(22) Filed: Jul. 17, 2018

(30) Foreign Application Priority Data
Aug. 1, 2017 (JP) 2017-149322

(51) Int. Cl. B60C 11/01; B29D 30/06

(52) U.S. Cl. CPC B60C 11/01; B60C 2011/0341; B29D 2030/0612; B29D 30/0606

(57) ABSTRACT

A pneumatic tire includes: a tread including a tread surface; and a sidewall extending to an inner diameter side in a tire radial direction and formed continuous with an outer end in a tire width direction of the tread. A circumferential groove extending in a tire circumferential direction is formed in the sidewall. The circumferential groove includes a plurality of circumferential groove portions which are arranged at intervals in the tire circumferential direction without overlapping each other in the tire radial direction. Each of the plurality of circumferential groove portions extends obliquely with respect to the tire circumferential direction, and is located in a tire radial direction range which is not less than 4% and not larger than 40%, of a tire sectional height from an outermost diameter end position of the tread surface to the inner diameter side in a side view of the pneumatic tire.

### CROSS-REFERENCE TO RELATED APPLICATIONS

This application claims priority of Japanese Patent Application No. 2017-149322 filed on Aug. 1, 2017, the content of which is incorporated herein by reference.

### BACKGROUND OF THE INVENTION

### Technical Field

The present invention relates to a pneumatic tire.

### Related Art

Japanese Unexamined Patent Application Publication No. 2014-237393 discloses a pneumatic tire in which a recess is provided in a buttress. The recess extends continuously or intermittently in parallel along a tire circumferential direction. According to Japanese Unexamined Patent Application Publication No. 2014-237393, by providing the recess in the buttress, a strain amount in the buttress can be decreased to obtain good rolling resistance, and pressure applied to a ground end in a tire width direction can be decreased to obtain good uneven wear resistance.

### SUMMARY

In the case where the recess extending in parallel to the tire circumferential direction is formed in a tire side (the buttress) of the pneumatic tire, the tire side tends to be bent and deformed in a tire width direction with the recess as a base point during load rolling. That is, by providing the recess in the tire side, rigidity of the tire side is easily decreased, which allows improvement of ride quality. However, on the other hand, steering stability is deteriorated due to the decrease in rigidity of the tire side.

An object of the present invention is to provide a pneumatic tire capable of improving the steering stability while suppressing deterioration of the ride quality.

One aspect of the present invention provides a pneumatic tire including: a tread including a tread surface; and a sidewall extending to an inner diameter side in a tire radial direction and formed continuous with an outer end in a tire width direction of the tread in which a circumferential groove extending in a tire circumferential direction is formed in the sidewall, the circumferential groove includes a plurality of circumferential groove portions which are arranged at intervals in the tire circumferential direction without overlapping each other in the tire radial direction, and each of the plurality of circumferential groove portions extends obliquely with respect to the tire circumferential direction, and is located in a tire radial direction range which is not less than 4% and not larger than 40%, of a tire sectional height from an outermost diameter end position of the tread surface to the inner diameter side in a side view of the pneumatic tire.

According to the present invention, the circumferential groove includes the plurality of circumferential groove portions extending obliquely with respect to the tire circumferential direction. Because the circumferential groove portion is provided in the tire radial direction range which is not less than 4% and not larger than 40%, of the tire sectional height, the circumferential groove portion constitutes a base point (a ridgeline of bending) of bending deformation of the sidewall during load rolling of the pneumatic tire.

At this point, the circumferential groove portion is inclined with respect to the tire circumferential direction, so that the ridgeline of the bending of the sidewall is also inclined with respect to the tire circumferential direction. As a result, the rigidity of the sidewall is moderately improved as compared to a case where the circumferential groove is formed in parallel along the tire circumferential direction, so that the sidewall can moderately be bent and deformed. That is, by moderately bending and deforming the sidewall, the rigidity of the pneumatic tire and the steering stability can be improved while the deterioration of ride quality is suppressed.

Preferably the circumferential groove is inclined in the tire radial direction at an angle which is not less than 5° and not larger than 30°, with respect to the tire circumferential direction.

In this configuration, the circumferential groove portion is inclined in the tire radial direction at an angle which is not less then 5° and not larger than 30°, with respect to the tire circumferential direction, so that the sidewall can further moderately be bent and deformed. When the inclination angle of the circumferential groove portion with respect to the tire circumferential direction is less than 5°, an effect of improving the rigidity of the sidewall by the circumferential groove portion is not effectively obtained. When the inclination angle is larger than 30°, the rigidity of the sidewall is easily excessively improved. In this case, because the circumferential groove portion hardly constitutes the base point during the bending deformation of the sidewall, the sidewall is hardly bent and deformed, and the ride quality tends to be deteriorated.

Preferably the interval between the circumferential groove portions adjacent to each other in the tire circumferential direction is not less than 0.5 mm and not larger than 7 mm.

According to this configuration, in the tire vulcanizing mold, the plurality of circumferential groove forming protrusions for forming the circumferential groove portion are located at intervals which is not less than 0.7 mm and not larger than 7 mm, in the tire circumferential direction. Consequently, during the vulcanizing molding, the air of the surface of the green tire and/or the air interposed in the rubber interface can suitably be moved in the tire radial direction through between the adjacent circumferential groove forming protrusions to suppress the residual air failure.

When each of the intervals is less than 0.5 mm, the air of the surface of the green tire and/or the air interposed in the rubber interface is hardly moved in the tire radial direction through between the circumferential groove forming protrusions adjacent to each other in the tire circumferential direction during the vulcanizing molding. When each of the intervals is larger than 7 mm, the number of pressing portions of the rubber interface by the circumferential groove forming protrusion is insufficient.

The circumferential groove portion may include a plurality of grooves provided in a plurality of rows in the tire radial direction.

The circumferential groove portion may include a plurality of grooves provided intermittently in the tire circumferential direction, and at least one of the grooves may traverse an outer end of the rubber interface in the tire radial direction.

The circumferential groove portion may be formed by providing a plurality of recesses having a dimple shape, and at least one of the recesses may traverse an outer end of the rubber interface in the tire radial direction.

The plurality of circumferential groove portions adjacent to each other in the tire circumferential direction are configured to alternately or randomly change an inclination direction with respect to the tire circumferential direction to an outer diameter side and an inner diameter side in the tire radial direction.

According to the present invention, in a pneumatic tire, the peeling of the rubber interface between the tread rubber and the sidewall rubber is suppressed while the residual air failure is suppressed during the vulcanizing molding.

### BRIEF DESCRIPTION OF THE DRAWINGS

The foregoing and the other features of the present invention will become apparent from the following description and drawings of an illustrative embodiment of the invention in which:

FIG. 1 is a meridian sectional view of a pneumatic tire according to a first embodiment;

FIG. 2 is an enlarged view illustrating surroundings of a circumferential groove portion as viewed from arrow A in FIG. 1;

FIG. 3 is a sectional view taken along line III-III in FIG. 2;

FIG. 4 is an enlarged view illustrating a molding surface of a tire vulcanizing mold when the molding surface is viewed from arrow B in FIG. 3;

FIG. 5A is an enlarged view, which is similar to FIG. 2 and illustrates a circumferential groove portion according to one modification;

FIG. 5B is an enlarged view, which is similar to FIG. 2 and illustrates a circumferential groove portion according to another modification;

FIG. 5C is an enlarged view, which is similar to FIG. 2 and illustrates a circumferential groove portion according to still another modification;

FIG. 5D is an enlarged view, which is similar to FIG. 2 and illustrates a circumferential groove portion according to yet another modification;

FIG. 5E is an enlarged view, which is similar to FIG. 2 and illustrates a circumferential groove portion according to yet another modification;

FIG. 5F is an enlarged view, which is similar to FIG. 2 and illustrates a circumferential groove portion according to yet another modification;

FIG. 5G is an enlarged view, which is similar to FIG. 2 and illustrates a circumferential groove portion according to yet another modification;

FIG. 6 is a meridian sectional view of a pneumatic tire according to a second embodiment;

FIG. 7 is an enlarged view illustrating surroundings of a circumferential groove portion as viewed from arrow C in FIG. 6;

FIG. 8 is a sectional view taken along line VIII-VIII in FIG. 7;

FIG. 9 is an enlarged view illustrating a molding surface of a tire vulcanizing mold as viewed from arrow D in FIG. 8; and

FIG. 10 is an enlarged view, which is similar to FIG. 2 and illustrates a circumferential groove portion of a pneumatic tire according to a comparative example.

### DETAILED DESCRIPTION OF EMBODIMENTS

Hereinafter, embodiments of the present invention will be described with reference to the accompanying drawings. It should be noted that the following description is merely exemplary in nature and is not intended to limit the invention, its application, or its use. Also, the drawings are schematic, and ratios of distances are different from actual ones.

### First Embodiment

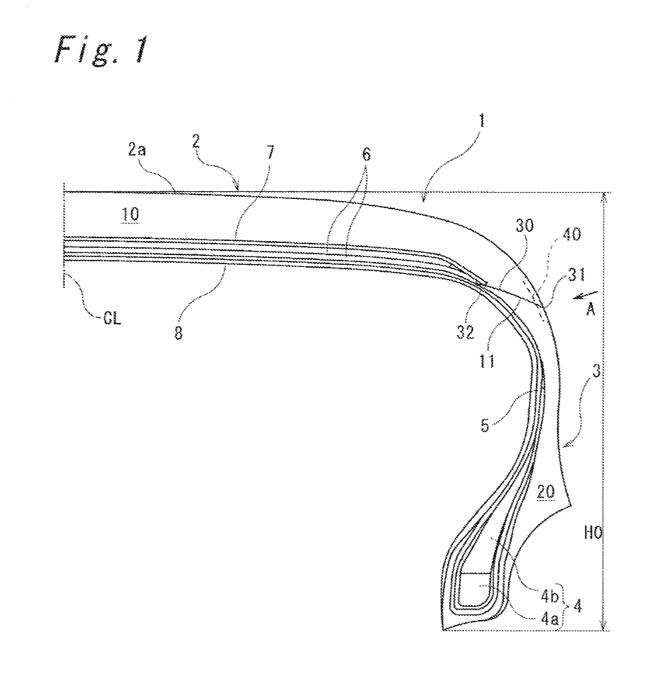

FIG. 1 is a half sectional view of a pneumatic tire according to a first embodiment of the present invention in a meridian direction, and illustrates only one side with respect to tire equator line CL. As illustrated in FIG. 1, a pneumatic tire 1 includes a tread 2 including a tread surface 2a, a pair of sidewalls 3 that extends to inner diameter side in a tire radial direction while being continuous with an outer end in a tire width direction, and a pair of beads 4 located at inner diameter ends of the sidewalls 3. On tire inner surface sides of the tread 2 and the sidewall 3, a carcass ply 5 is disposed so as to be bridged between the pair of beads 4.

A belt layer 6 and a belt reinforcing layer 7 are sequentially disposed on an outside in the tire radial direction of the carcass ply 5 of the tread 2, and a tread rubber 10 is disposed on the outside of the belt reinforcing layer 7. An inner ply 8 holding air pressure is disposed on the inside of the carcass ply 5. The bead 4 includes a bead core 4a having an annular shape and formed by rubber-coating a bundle such as steel wires and a bead filler 4b having an annular shape and a triangular section, the bead filler 4b extending outwardly in the tire radial direction while being continuous with the bead core 4a.

A sidewall rubber 20 is disposed in the sidewall 3. The sidewall rubber 20 extends to an inner diameter side in the tire radial direction while being continuous with an outer end inner diameter surface 11 of the tread rubber 10, and reaches the bead 4 along an outer surface of the carcass ply 5. That is, the pneumatic tire 1 has what is called a tread over sidewall (TOS) structure in which the tread rubber 10 is disposed so as to cover the sidewall rubber 20 from an outer diameter side in the tire radial direction.

A rubber interface 30 between the tread rubber 10 and the sidewall rubber 20 includes an outer end 31 exposed on an outer surface of the pneumatic tire 1 and an inner end 32 located on the inside in the tire width direction, and the rubber interface 30 extends substantially along the tire width direction between the outer end 31 and the inner end 32. A circumferential groove 40, which extends substantially along a tire circumferential direction while traversing the outer end 31 of the rubber interface 30 in the tire radial direction, is formed in the outer surface of the pneumatic tire 1 as indicated by a broken line in FIG. 1.

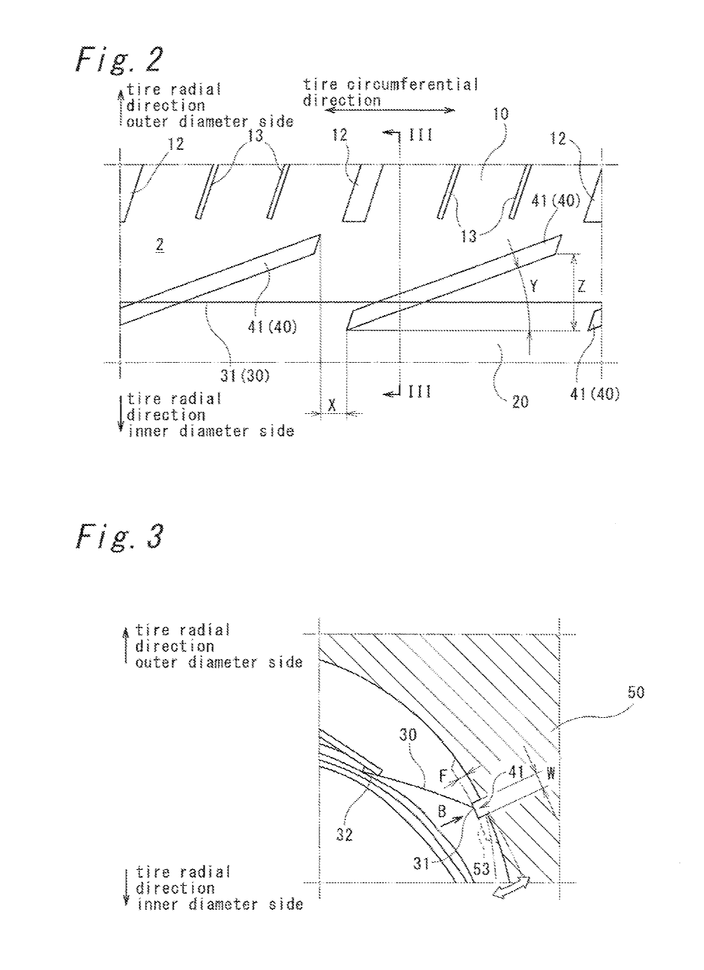

FIG. 2 is an enlarged view illustrating a main part of surroundings of the circumferential groove 40 as viewed from arrow A in FIG. 1. In FIG. 2, the tire circumferential direction is illustrated unfolded so as to extend in a horizontal direction. A plurality of lug grooves 12 extending in the tire width direction and a plurality of lateral grooves 13 extending in the tire width direction between the lug grooves 12 adjacent to each other in the tire circumferential direction are formed in the tread 2 as illustrated in FIG. 2. The outer end 31 of the rubber interface 30 is exposed onto the inner diameter sides in the tire radial direction of the pluralities of lug grooves 12 and lateral grooves 13 so as to extend continuously in the tire circumferential direction.

The circumferential groove 40 includes a plurality of circumferential groove portions 41 that are arranged at intervals in the tire circumferential direction without overlapping each other in the tire radial direction on the inner diameter sides in the tire radial direction of the pluralities of lug grooves 12 and lateral grooves 13. Each of the plurality of circumferential groove portions 41 traverses the outer end 31 of the rubber interface 30 between the tread rubber 10 and the sidewall rubber 20 in the tire radial direction. Specifically, the circumferential groove portion 41 is recessed from the outer surface of the tire toward the inner surface side of the tire, and obliquely traverses the outer end 31 of the rubber interface 30 in the tire radial direction.

Preferably, in the tire circumferential direction, an interval X between the plurality of circumferential groove portions 41 adjacent to each other is set in a range which is not less than 0.5 mm and not larger than 7 mm. The circumferential groove portion 41 extends obliquely at an inclination angle Y with respect to the tire circumferential direction. The inclination angle Y is preferably set in a range which is not less than 5° and not larger than 30°. An amplitude (displacement amount) Z in the tire radial direction of the circumferential groove portion 41 is preferably set in a range which is not less than 2 mm and not larger than 20 mm.

The plurality of circumferential groove portions 41 are located in a tire radial direction range which is not less than 4% and not larger than 40%, of a tire reference sectional height H0 from an outermost diameter end position of the tread surface to the inner diameter side in a side view of the tire. Consequently, the circumferential groove portion 41 constitutes a base point (a ridgeline of bending) in the bending of the bending deformation of the sidewall 3 during the load rolling of the pneumatic tire.

Referring to FIG. 1, the tire reference sectional height H0 used herein means a height from the inner diameter side end of the bead 4 to the highest portion (an intersection of the tread surface and a tire equator line) in the outer surface of the tread 2. The tire reference sectional height H0 is measured using a sample corresponding to a predetermined range (for example, a range of 20 mm in the tire circumferential direction) in the tire circumferential direction of the pneumatic tire 1 cut in the tire radial direction. In the sample, a length between the pair of beads 4 is set at a standard rim width. The standard rim width is a rim specified in each tire by a standard system including a standard on which the tire is based. For example, a “standard rim” is used in JATMA, a “Design Rim” is used in TRA, and a “Measuring Rim” is used in ETRTO.

FIG. 3 is a sectional view taken along line III-III in FIG. 2, and also illustrates a tire vulcanizing mold 50 for performing the vulcanizing molding of the pneumatic tire 1. As illustrated in FIG. 3, in the tire vulcanizing mold 50, a plurality of circumferential groove forming protrusions 53 that form the circumferential groove portion 41 are provided. A section of the circumferential groove portion 41 is formed into a rectangular shape. In addition to the rectangular section, suitable sectional shapes such as a semicircular section and a triangular section can be used as the sectional shape of the circumferential groove portion 41. The circumferential groove portion 41 has a groove width W which is not less than 0.5 mm and not larger than 7 mm and a groove depth F which is not less than 0.3 mm and not larger than 6 mm.

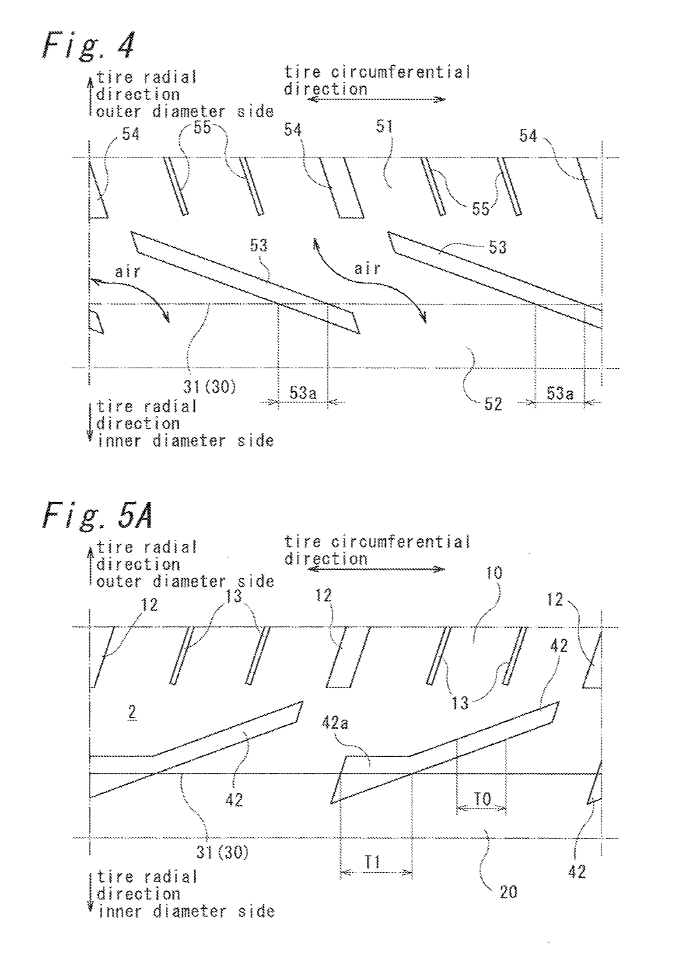

FIG. 4 is an enlarged view illustrating a main part of a molding surface of the tire vulcanizing mold 50 as viewed from arrow B in FIG. 3. In FIG. 4, the outer end 31 of the rubber interface 30 of a green tire to be vulcanized using the tire vulcanizing mold 50 is indicated by a two-dot chain line. As illustrated in FIG. 4, the plurality of circumferential groove forming protrusions 53 are arranged at intervals in the tire circumferential direction without overlapping each other in the tire radial direction. The circumferential groove forming protrusion 53 includes an interface traversing portion 53a in a portion intersecting the outer end 31 of the rubber interface 30. In other words, the circumferential groove forming protrusion 53 traverses, at the interface traversing portion 53a, the outer end 31 of the rubber interface 30 in the tire radial direction.

A lug groove forming protrusion 54 for molding the lug groove 12 and a lateral groove forming protrusion 55 for molding the lateral groove 13 are provided in the tire vulcanizing mold 50.

According to the present embodiment, as illustrated in FIG. 2, the plurality of circumferential groove portions 41 traverse the outer end 31 of the rubber interface 30 between the tread rubber 10 and the sidewall rubber 20 in the tire radial direction. That is, as illustrated in FIG. 4, in the tire vulcanizing mold 50, the plurality of circumferential groove forming protrusions 53 are located so as to traverse the outer end 31 of the rubber interface 30 in the tire radial direction at the interface traversing portion 53a. As a result, during vulcanizing molding, the green tire is intermittently pressed in the tire circumferential direction in at least the outer end 31 of the rubber interface 30 by the interface traversing portion 53a of each of the plurality of circumferential groove forming protrusions 53, so that adhesion of the rubber interface 30 is improved to suppress the peeling between the tread rubber 10 and the sidewall rubber 20.

As schematically indicated by an outlined arrow in FIG. 3, the sidewall 3 is bent and deformed in the tire width direction with the circumferential groove portion 41 as the base point during the tire load rolling. In this case, the circumferential groove portion 41 extends obliquely with respect to the tire circumferential direction while the rubber interface 30 extends in the tire circumferential direction, so that the base point of the bending deformation is not matched with the rubber interface 30. That is, the rubber interface 30 is not matched with the base point which distortion tends to concentrate on, so that a crack is suppressed in the circumferential groove portion 41 constituting the base point.

On the other hand, as illustrated in FIG. 10, in the case that a circumferential groove portion 241 is provided so as to extend in the tire circumferential direction along the outer end 31 of the rubber interface 30, during the load rolling, the sidewall 3 is bent and deformed in the tire width direction with a circumferential groove portion 241 as the base point, and the base point of the bending deformation is matched with the rubber interface 30. In this case, distortion tends to concentrate on the rubber interface 30, and the crack is easy to generate.

Further, as illustrated in FIG. 2, because the plurality of circumferential groove portions 41 are arranged at intervals X in the tire circumferential direction without overlapping each other in the tire radial direction, bending rigidity of the side wall 3 is easily substantially equalized with the circumferential groove portion 41 as the base point, and the bending deformation in the tire width direction is easily equalized in the tire circumferential direction with the circumferential groove portion 41 of the sidewall 3 as the base point during the load rolling of the pneumatic tire 1.

As illustrated in FIG. 4, in the tire vulcanizing mold 50, the plurality of circumferential groove forming protrusions 53 are intermittently formed in the tire circumferential direction, so that air of the surface of the green tire and/or air interposed in the rubber interface 30 can be moved in the tire radial direction through between the adjacent circumferential groove forming protrusions 53 to suppress generation of air accumulation. Consequently, the residual air failure can be suppressed during the vulcanizing molding even when the circumferential groove forming protrusions 53 extending in the tire circumferential direction are formed in the tire vulcanizing mold 50.

Because the interval X between the plurality of circumferential groove portions 41 is set in the range which is not less than 0.5 mm and not larger than 7 mm, in the tire vulcanizing mold 50, the plurality of circumferential groove forming protrusions 53 are arranged at intervals which is not less than 0.5 mm and not larger than 7 mm, in the tire circumferential direction. Consequently, during the vulcanizing molding, the air of the surface of the green tire and/or the air interposed in the rubber interface can suitably be moved in the tire radial direction through between the adjacent circumferential groove forming protrusions to suppress the residual air failure.

When the interval X is less than 0.5 mm, the air of the surface of the green tire and/or the air interposed in the rubber interface 30 is hardly moved in the tire radial direction through the interval X during the vulcanizing molding. When the interval X is larger than 7 mm, the number of portions pressing the outer end 31 of the rubber interface 30 by the circumferential groove forming protrusion 53 is insufficient.

In the circumferential groove portion 41, the inclination angle Y with respect to the tire circumferential direction is not less than 5° and not larger than 30°, so that the circumferential groove portion 41 is inclined with respect to the tire circumferential direction. Consequently, the ridgeline of the bending of the sidewall 3 is also inclined with respect to the tire circumferential direction. As a result, the rigidity of the sidewall 3 is moderately improved as compared to a case where the circumferential groove 40 is formed in parallel along the tire circumferential direction, so that the sidewall 3 can moderately be bent and deformed. That is, by moderately bending and deforming the sidewall 3, the rigidity of the pneumatic tire 1 and the steering stability can be improved while the deterioration of the ride quality is suppressed.

When the inclination angle Y of the circumferential groove portion 41 with respect to the tire circumferential direction is less than 5°, an effect of improving the rigidity of the sidewall 3 by the circumferential groove portion 41 is not effectively obtained. When the inclination angle Y is larger than 30°, the rigidity of the sidewall 3 is easily excessively improved. In this case, because the circumferential groove portion 41 hardly constitutes the base point during the bending deformation of the sidewall 3, the sidewall 3 is hardly bent and deformed, and the ride quality tends to be deteriorated.

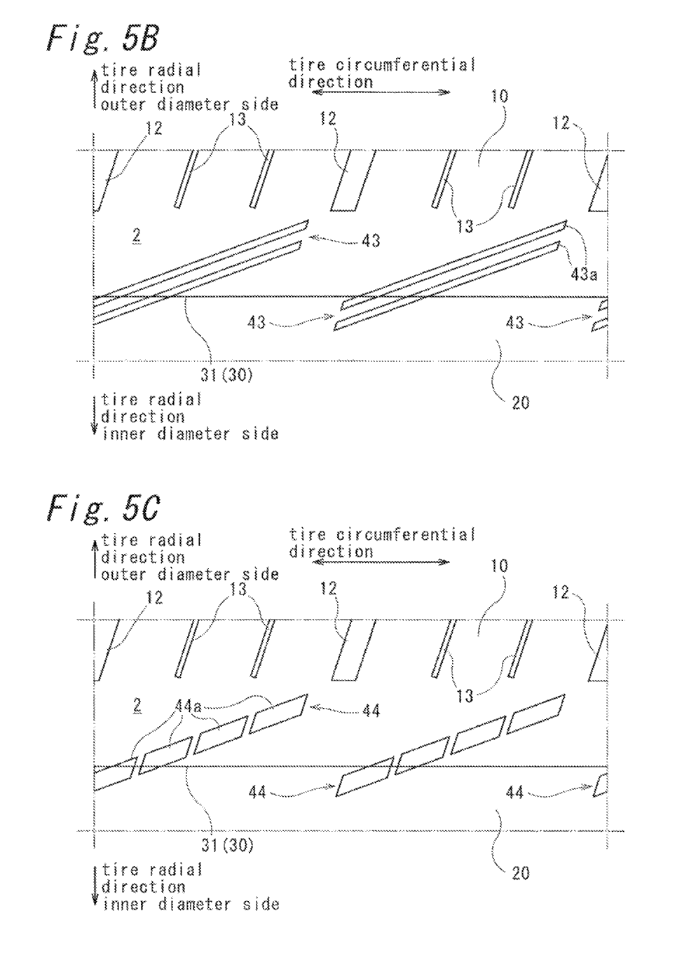

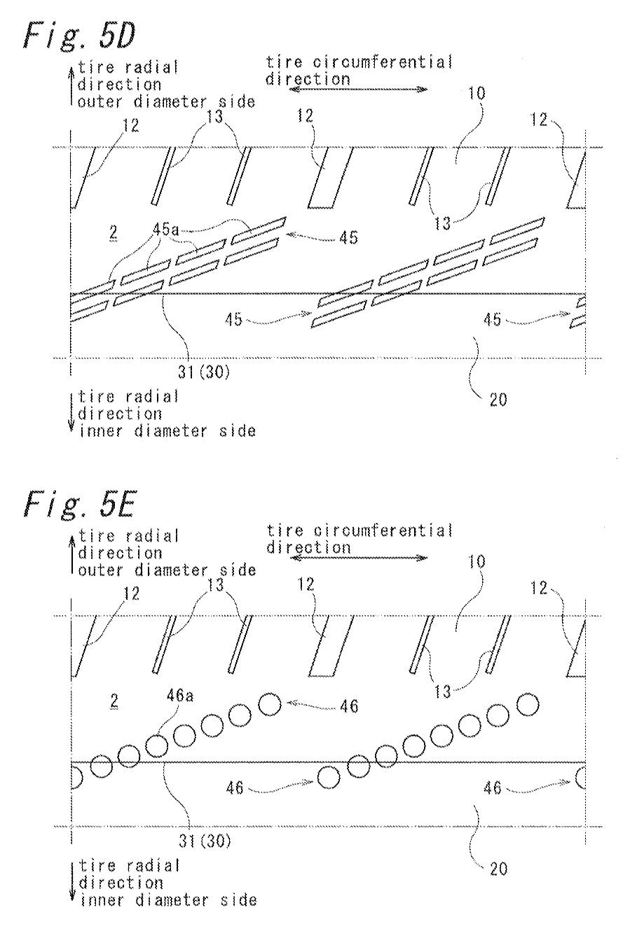

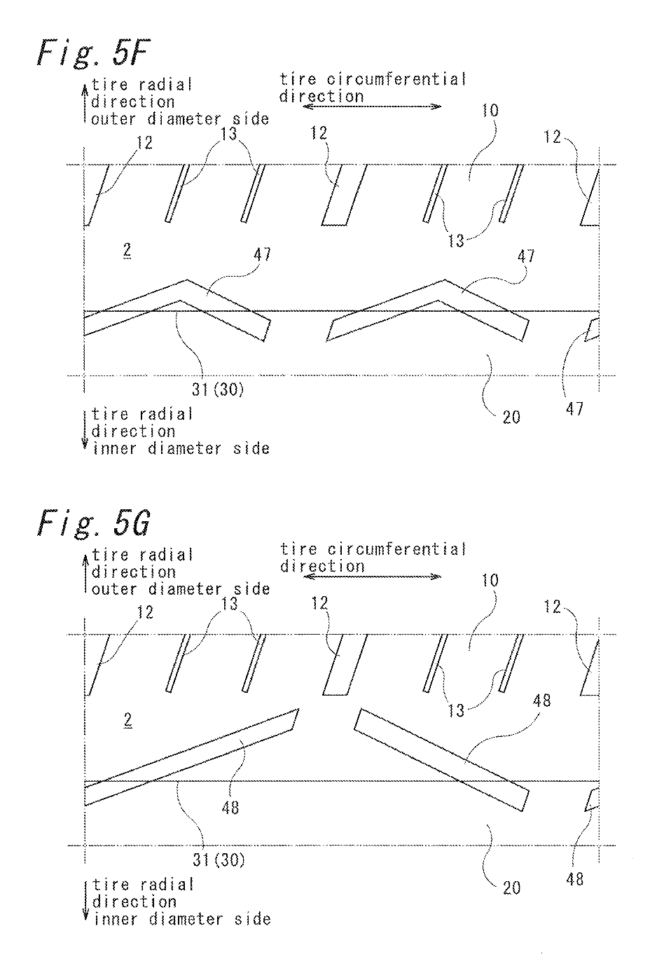

FIGS. 5A to 5G illustrate circumferential groove portions 42 to 48 according to modifications. Referring to FIG. 5A, the circumferential groove portion 42 includes a wide portion 42a. The wide portion 42a is configured such that a groove width T1 in the tire circumferential direction of a portion corresponding to the outer end 31 of the rubber interface 30 is wider than a groove width T0 of a remaining portion.

As a result, the tire vulcanizing mold 50 includes a wide protrusion (not illustrated) formed widely in the tire circumferential direction in the portion in which the circumferential groove forming protrusion 53 for forming the circumferential groove portion 42 traverses the outer end 31 of the rubber interface 30 between the tread rubber 10 and the sidewall rubber 20. As a result, a pressing length of the rubber interface 30 by the circumferential groove forming protrusion 53 is made longer by the wide protrusion, so that the peeling of the rubber interface 30 is further suppressed during vulcanizing molding.

As illustrated in FIG. 5B, the circumferential groove portion 43 may include a plurality of grooves 43a arranged in a plurality of rows in the tire radial direction. In this case, each of the grooves 43a has the same length extending in parallel to the tire circumferential direction. That is, since the plurality of grooves 43a not partially but wholly overlap each other in the tire radial direction, the bending deformation in the tire width direction of the sidewall 3 is easily equalized in the tire circumferential direction. Because each of the grooves 43a arranged in the plurality of rows traverses the outer end 31 of the rubber interface 30 in the tire radial direction, during the vulcanizing molding, the outer end 31 is pressed by the circumferential groove forming protrusions 53 at a plurality of points, and the peeling of the rubber interface 30 is further suppressed.

As illustrated in FIG. 5C, the circumferential groove portion 44 may include a plurality of grooves 44a provided intermittently in the tire circumferential direction. In this case, at least one groove 44a traverses outer end 31 of the rubber interface 30 in the tire radial direction.

As illustrated in FIG. 5D, the circumferential groove portion 45 may be configured by arranging groove rows including a plurality of grooves 45a provided intermittently in the tire circumferential direction in a plurality of rows in the tire radial direction. In this case, at least one groove 45a traverses the outer end 31 of the rubber interface 30 in the tire radial direction.

As illustrated in FIG. 5E, the circumferential groove portion 46 may be formed by arranging a plurality of recesses 46a having a dimple shape. In this case, at least one recess 46a traverses the outer end 31 of the rubber interface 30 in the tire radial direction.

As illustrated in FIG. 5F, the circumferential groove portion 47 may be bent in the tire radial direction so as to traverse the outer end 31 of the rubber interface 30 at a plurality of points. Although not illustrated, the circumferential groove portion may be curved, or may be formed into a wave shape such as a sinusoidal wave so as to traverse the outer end 31 of the rubber interface 30 at two or more points.

As a result, in the tire vulcanizing mold 50, the circumferential groove forming protrusion 53 for forming the circumferential groove portion 47 is formed so as to traverse the outer end 31 of the rubber interface 30 between the tread rubber 10 and the sidewall rubber 20 at a plurality of points. Consequently, during the vulcanizing molding, the number of pressing positions of the outer end 31 of the rubber interface 30 by the circumferential groove forming protrusion 53 increases, so that the peeling of the rubber interface 30 is further suppressed.

As illustrated in FIG. 5G, a plurality of circumferential groove portion 48 adjacent to each other in the tire circumferential direction may be configured such that an inclination direction with respect to the tire circumferential directions are alternately or randomly changed to the outer diameter side and the inner diameter side in the tire radial direction.

### Second Embodiment

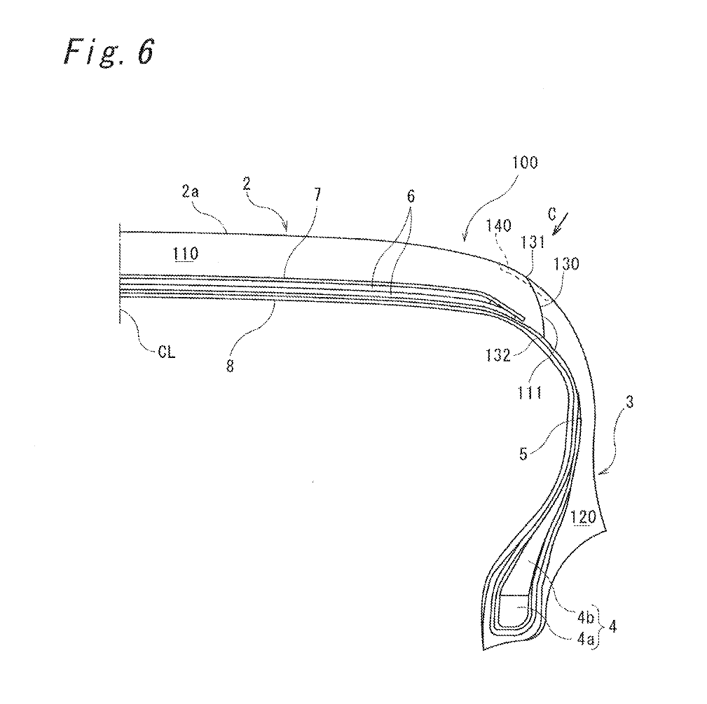

FIGS. 6 to 9 illustrate a pneumatic tire 100 according to a second embodiment. As illustrated in FIG. 6, the pneumatic tire 100 is what is called a sidewall on tread (SWOT) structure in which an outside end in a tire radial direction of a sidewall rubber 120 is disposed so as to cover an outer end surface 111 in a tire width direction of a tread rubber 110 from an outside in the tire width direction. That is, in the present embodiment, the present invention is applied to the pneumatic tire 100 having the SWOT structure. In the following description, a difference from the pneumatic tire 1 of the first embodiment will mainly be described in detail, the common parts are denoted by the same reference numerals as those in the first embodiment, and the description will be omitted.

By adopting the SWOT structure, the sidewall rubber 120 can be disposed in a wider range to the outer end in the tire width direction of the tread 2. In the case where a rubber member having improved weather resistance (for example, ozone resistance) is adopted for the sidewall rubber 120, the weather resistance of the pneumatic tire 100 can be improved.

The rubber interface 130 between the tread rubber 110 and the sidewall rubber 120 includes an outer end 131 exposed to an outer surface of the pneumatic tire 100 and an inner end 132 located on an inner diameter side in the tire radial direction. The rubber interface 130 extends substantially along the tire radial direction between the outer end 131 and the inner end 132. A circumferential groove 140, which extends substantially along the tire circumferential direction while traversing the outer end 131 of the rubber interface 130 in the tire radial direction, is formed on the outer surface of the pneumatic tire 100 as indicated by a broken line in FIG. 6.

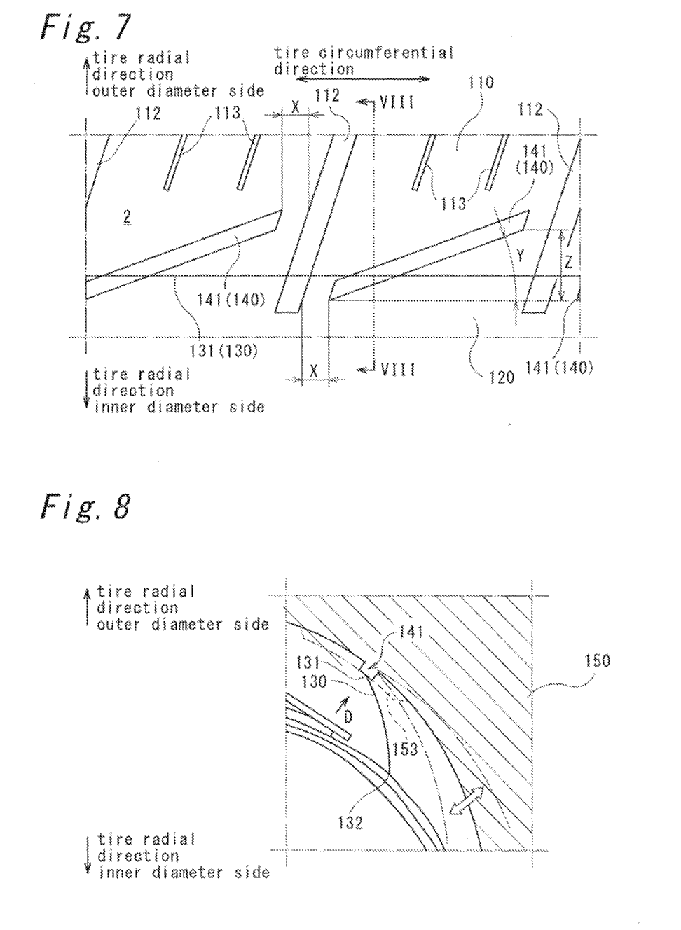

FIG. 7 is an enlarged view illustrating a main part of surroundings of the circumferential groove 140 as viewed from arrow C in FIG. 6. A plurality of lug grooves 112 extending in the tire width direction and a plurality of lateral grooves 113 extending in the tire width direction between the lug grooves 112 adjacent to each other in the tire circumferential direction are formed in the tread 2 as illustrated in FIG. 7. The plurality of lug grooves 112 extend in the tire radial direction so as to traverse the outer end 131 of the rubber interface 130. On the other hand, the plurality of lateral grooves 113 terminate at the outer diameter side in the tire radial direction with respect to the outer end 131 of the rubber interface 130.

The circumferential groove 140 extending in the tire circumferential direction is formed between the lug grooves 112 adjacent to each other in the tire circumferential direction. The circumferential groove 140 includes a plurality of circumferential groove portions 141 that are arranged at intervals in the tire circumferential direction without overlapping each other in the tire radial direction. Each circumferential groove portion 141 does not communicate with the lug groove 112, and has an interval X in the tire circumferential direction with respect to the lug groove 112. Similarly to the circumferential groove portion 41 of the first embodiment, the circumferential groove portion 141 is inclined at an inclination angle Y with respect to the tire circumferential direction and an amplitude Z in the tire radial direction is set. The interval X, the inclination angle Y, and the amplitude Z can be set to the same numerical ranges as those of the first embodiment.

Each of the plurality of circumferential groove portions 141 traverses the outer end 131 of the rubber interface 130 between the tread rubber 110 and the sidewall rubber 120 in the tire radial direction. Specifically, the circumferential groove portion 141 is recessed from the outer surface of the tire toward the inner surface side of the tire, and obliquely traverses the outer end 131 of the rubber interface 130 in the tire radial direction.

The plurality of circumferential groove portions 141 are located in a tire radial direction range which is not less than 4% and not larger than 40%, of a tire sectional height from an outermost diameter end position of the tread, surface to the inner diameter side in a side view of the tire. Consequently, the circumferential groove portion 141 constitutes a base point (a ridgeline of bending) in the bending of the bending deformation of the sidewall 3 during the load rolling of the pneumatic tire.

FIG. 8 is a sectional view taken along line VIII-VIII in FIG. 7, and also illustrates a tire vulcanizing mold 150 for performing the vulcanizing molding of the pneumatic tire 100. As illustrated in FIG. 8, in the tire vulcanizing mold 150, a plurality of circumferential groove forming protrusions 153 that form the circumferential groove portion 141 are provided.

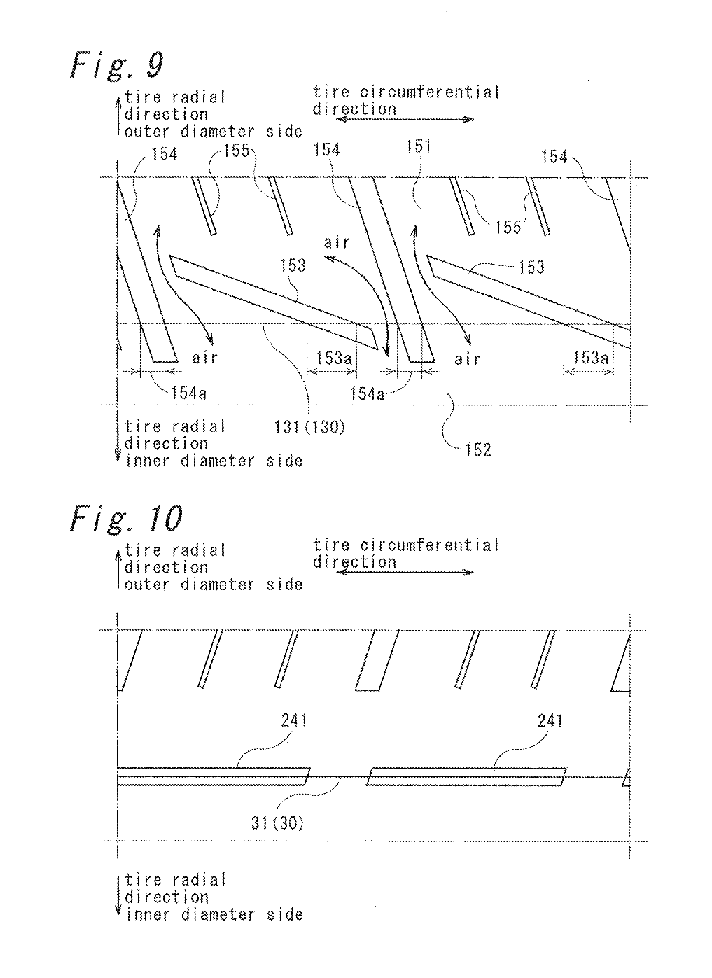

FIG. 9 is an enlarged view illustrating a main part of a molding surface of the tire vulcanizing mold 150 as viewed from arrow D in FIG. 8. In FIG. 9, the outer end 131 of the rubber interface 130 of a green tire to be vulcanized using the tire vulcanizing mold 150 is indicated by a two-dot chain line. As illustrated in FIG. 9, the plurality of circumferential groove forming protrusions 153 are arranged at intervals in the tire circumferential direction without overlapping each other in the tire radial direction. In the tire vulcanizing mold 150, a lug groove forming protrusion 154 for forming the lug groove 112 is provided between the circumferential groove forming protrusions 153 adjacent to each other in the tire circumferential direction. In the tire vulcanizing mold 150, a plurality of lateral groove forming protrusions 155 for forming the lateral grooves 113 are formed between the lug groove forming protrusions 154 adjacent to each other in the tire circumferential direction.

The circumferential groove forming protrusion 153 and the lug groove forming protrusion 154 include interface traversing portions 153a, 154a at a portion intersecting the outer end 131 of the rubber interface 130, respectively. In other words, the interface traversing portions 153a, 154a of the plurality of circumferential groove forming protrusions 153 and the lug groove forming protrusions 154 traverse the rubber interface 130 of the green tire at least in the outer end 131 in the tire radial direction.

Also in the present embodiment, because the circumferential groove portion 141 is inclined with respect to the tire circumferential direction, the rigidity of the sidewall 3 is moderately improved as compared to a case where the circumferential groove portion 140 is formed in parallel along the tire circumferential direction, which allows the sidewall 3 to be moderately bent and deformed. That is, by moderately bending and deforming the sidewall 3, the rigidity of the pneumatic tire 1 and the steering stability can be improved while the deterioration of the ride quality is suppressed.

According to the present embodiment, in the tire vulcanizing mold 130, the lug groove forming protrusion 154 for forming the lug groove 112 is provided between the adjacent circumferential groove forming protrusions 153. As a result, during the vulcanizing molding, the rubber interface 130 is also pressed by the interface traversing portion 154a of the lug groove forming protrusion 154 in addition to the interface traversing portion 153a of the circumferential groove forming protrusion 153, so that the number of pressing positions of the rubber interface 130 increases to further suppress the peeling of the rubber interface 130.

In the first embodiment, the lug groove 12 is located on the outer diameter side in the tire radial direction with respect to the outer end 31 of the rubber interface 30. However, as in the second embodiment, the lug groove 12 may be provided so as to traverse the outer end 31 of the rubber interface 30 in the tire radial direction.

The specifications of the tire vulcanizing molds 50, 150 are not particularly limited. For example, a two-piece mold divided into two in the tire width direction may be adopted, or a segmented mold in which a tread ring forming the tread is divided into a plurality of pieces in the tire circumferential direction may be adopted.

Evaluation tests of the ride quality, the steering stability, and hydroplaning performance (drainability) were performed on tires of Comparative Examples 1, 2 and Example 1.

Comparative Example 1 is the tire in FIG. 10, and the circumferential groove portions 241 are arranged so as to extend in the tire circumferential direction. A groove depth F of the circumferential groove portion 241 is set to 2.0 mm.

In the tire of Comparative Example 2 is different from the tire of Comparative Example 1 only in the groove depth F of the circumferential groove portion 241. That is, the groove depth F of the circumferential groove portion 241 of Comparative Example 2 is set to 0.5 mm, which is shallower than that of Comparative Example 1.

The tire of Example 1 is one of the first embodiment.

In the evaluation tests of the ride quality, the steering stability, and the hydroplaning performance, a test tire (tire size 225/45R17) was set to air pressure of 230 kPa, and 17×7.5-JJ was used for the rim to be mounted.

For the evaluation of the ride quality, comparison by sensory evaluation of dry road traveling was performed using an actual vehicle.

For the evaluation of the steering stability, comparison by the sensory evaluation of the dry road traveling was performed using the actual vehicle. Comparative Example 2 and Example 1 were evaluated with the evaluation results of Comparative Example 1 represented by an index of 100. Preferably the steering stability is improved as the index increases.

The evaluation of the hydroplaning performance was performed by attaching each tire to the vehicle, and measuring a speed at which one of wheels in a waterway having a water depth of 10 mm and the other wheel on a straight, dry road reached 10% of a difference in slip ratio between right and left wheels. The evaluation was performed with the index in which the result of Comparative Example 1 is set to 100, and the straight hydroplaning performance is excellent as the index increases.

Table 1 illustrates the results of the evaluation tests.

TABLE 1

| | Comparative | Comparative | |
|---|---|---|---|
| | Example 1 | Example 2 | Example 1 |
| Ride quality | 100 | 97 | 99 |
| Steering | 100 | 110 | 107 |
| stability | | | |
| Hydroplaning | 100 | 94 | 100 |
| performance | | | |

In Comparative Example 2 in which the groove depth F of the circumferential groove portion 241 extending in the tire circumferential direction was set shallower than that of Comparative Example 1, the decrease in rigidity of the tire side can be suppressed as compared to Comparative Example 1, so that the steering stability can be improved while the ride quality is maintained. However, in Comparative Example 2, because the groove depth F of the circumferential groove portion 241 was set shallower, the hydroplaning performance (drainability) was rather degraded. On the other hand, in Example 1, the ride quality was substantially equal to that of Comparative Example 1, and the performance better than Comparative Example 2 is obtained. Additionally, in Example 1, the performance better than Comparative Examples 1, 2 is obtained for both the steering stability and the hydroplaning performance.

What is claimed is:

1. A pneumatic tire comprising:
a tread including a tread surface; and
a sidewall extending to an inner diameter side in a tire radial direction and formed continuous with an outer end in a tire width direction of the tread,
wherein a circumferential groove extending in a tire circumferential direction is formed in the sidewall,
the circumferential groove includes a plurality of circumferential groove portions which are arranged at intervals in the tire circumferential direction without overlapping each other in the tire radial direction, and
each or the plurality of circumferential groove portions extends obliquely with respect to the tire circumferential direction, and is located in a tire radial direction range which is not less than 4% and not larger than 40%, of a tire sectional height from an outermost diameter end position of the tread surface to the inner diameter side in a side view of the pneumatic tire.

2. The pneumatic tire according to claim 1, wherein the circumferential groove portion is inclined in the tire radial direction at an angle which is not less than 5° and not larger than 30°, with respect to the tire circumferential direction.

3. The pneumatic tire according to claim 1, wherein each of the intervals between the circumferential groove portions adjacent to each other in the tire circumferential direction is not less than 0.5 mm and not larger than 7 mm.

4. The pneumatic tire according to claim 1, wherein the circumferential groove portion includes a plurality of grooves provided in a plurality of rows in the tire radial direction.

5. The pneumatic tire according to claim 1, wherein the circumferential groove portion includes a plurality of grooves provided intermittently in the tire circumferential direction, and at least one of the grooves traverses an outer end of the rubber interface in the tire radial direction.

6. The pneumatic tire according to claim 1, wherein the circumferential groove portion is formed by providing a plurality of recesses having a dimple shape, and at least one of the recesses traverses an outer end of the rubber interface in the tire radial direction.

7. The pneumatic tire according to claim 1, wherein the plurality of circumferential groove portions adjacent to each other in the tire circumferential direction are configured to alternately or randomly change an inclination direction with respect to the tire circumferential direction to an outer diameter side and an inner diameter side in the tire radial direction.
